(19) United States
(12) Patent Application Publication
(10) Pub. No.: US 2006/0112913 A1
(43) Pub. Date: Jun. 1, 2006

(54) Internal combustion engine

(76) Inventor: Edward Lawrence Warren, West MeIbourne, FL (US)

Correspondence Address: Edward L. Warren, 3912 Snowy Egret Dr., West Melbourne, FL, 32904, US

(21) Appl. No.: 10/998,285

(22) Filed: Nov. 26, 2004

(51) Int. Cl. F02B 33/00

(52) U.S. Cl. 123/68

(57) ABSTRACT

The mechanization of a hot air engine cycle consisting of almost constant temperature compression, heat added from regeneration at constant pressure, heat added at constant volume, adiabatic expansion, and heat rejected to regeneration. Almost constant temperature compression is achieved by using a multi-stage-intercooled compressor. Heat is added at constant pressure by means of an exhaust gas to compressed air heat exchanger. Combustion heat is added at constant volume by means of a piston arrangement in the expansion cylinder. Adiabatic expansion takes place all the way to ambient pressure. The engine has dynamic braking by compressing air into storage to slow down the load. A clutch is used to disconnect the compressor, and the compressed air in storage is used to operate the engine. This results in an increase in maximum work output equal to the work of compression.

The patent application of Edward L. Warren, U.S.A. citizen, resident of 3912 Snowy Egret Dr., Melbourne, Fla. 32904 USA, inventor of the “Improved Internal Combustion Engine”.

### BACKGROUND

1. Field of Invention

The present invention relates to a reciprocating, internal combustion engine with a compressor, a heat exchanger, and an expander.

2. Description of Prior Art

Prior art improves the most popular engine in use today by 1. Separating the compression from the expansion process, 2. Compressing at almost constant temperature, 3. Using exhaust heat to heat the compressed air at constant pressure. These are the subjects of U.S. Pat. No. 3,708,979 to Bush et al. (1973), U.S. Pat. No. 4,040,400 to Kiener (1977), U.S. Pat. No. 4,333,424 to McFee (1982), and U.S. Pat. No. 4,476,821 to Robinson et al (1984).

What is also needed to improve the most popular engine in use today is adding heat at constant volume, and using the compressor to slow the load and storing the compressed air in a storage tank. These are the subjects of this patent.

### SUMMARY

The present invention is an approximate mechanization of a hot air engine cycle comprising constant temperature compression, heat added from regeneration at constant pressure, heat added at constant volume, adiabatic expansion, heat transferred to regeneration, and heat rejected from cooling the compression.

Approximate constant temperature compression is achieved by using a multi-stage-intercooled compressor. Heat is added at constant pressure by means of an exhaust gas to compressed air heat exchanger. Compressed air is moved into the clearance volume at a constant pressure, and heat is added at constant volume. Approximate constant volume heating is achieved by keeping the clearance volumes constant during burning in the same way as the Otto cycle engine keeps the clearance volume constant during burning. The four methods to keep the clearance volume constant are: a cam, a wobble plate, a pressurized telescoping connecting rod with synchronized lock in the cylinder, and a pusher piston. After constant volume heating adiabatic expansion takes place all the way to ambient pressure. The engine has dynamic braking by means of a compressor storing air in a storage tank.

### OBJECTS AND ADVANTAGES

The “Improved Internal Combustion Engine” has the following advantages:

It operates on a very efficient thermodynamic cycle.

It operates with close to complete expansion.

Heat is added to the compressed air at constant volume so that more work can be done with the heat that is added.

When the load slows down it saves the inertia work and reuses it.

It is quiet.

The compression and the expansion volumes are separated. The heat from one does not affect the other.

### DRAWING FIGURES

FIG. 1 shows preferred embodiment of the engine with approximate constant volume expansion achieved by keeping the power piston 14 close to the top of the expansion cylinder 12 using cam 28 along with push rod 29 and arm 33 to move it to the top and to keep it there until pusher piston 15 moves up to power piston 14.

FIG. 2 shows preferred embodiment of the engine with hot compressed air from heat exchanger high-pressure side 7 moved into clearance volume 19. Pusher piston 15 has moved up to power piston 14.

FIG. 3 shows preferred embodiment of the engine after fuel has been injected and burnt and expansion has taken place.

FIG. 4 shows the first alternate embodiment of the engine. It is the preferred embodiment of this invention with approximate constant volume expansion achieved by keeping the power piston 14 close to the top of the expansion cylinder 12 using wobble plate 30.

FIG. 5 shows the second alternate embodiment of the engine. It is the preferred embodiment of this invention with approximate constant volume expansion achieved by keeping power piston 14 close to the top of the expansion cylinder 12 using telescoping connecting rod 23 to move it to the top and lock 22 to keep it there during the intake of the hot compressed air.

FIG. 6 shows the third alternate embodiment of the engine. It is the preferred embodiment of this invention with approximate constant volume expansion achieved by keeping power piston 14 close to the top of the expansion cylinder 12 using telescoping connecting rod 23 to move it to the top and pusher piston 15 to keep it there during constant volume expansion.

FIG. 7 shows the fourth alternate embodiment of the engine. It is the preferred embodiment of this invention with heat exchanger 6 replaced with rotating heat exchanger 10

### REFERENCE NUMERALS IN DRAWINGS

2 expander
3 air inlet
4 compressor
5 compressed air storage tank
6 heat exchanger
7 heat exchanger high-pressure side
8 heat exchanger low-pressure side
9 inlet valve
10 rotating heat exchanger
11 rotating heat exchanger high-pressure side
12 expansion cylinder
13 rotating heat exchanger low-pressure side
14 power piston
15 pusher piston
17 exit valve
18 fuel injector
19 clearance volume
20 igniter
21 load
22 lock
23 telescoping connecting rod
24 pusher piston connecting rod
25 telescoping connecting rod crank
26 power output shaft
27 transmission
28 cam
29 push rod
30 wobble plate
31 pusher piston connecting rod crank
32 exhaust exit
33 arm
34 clutch

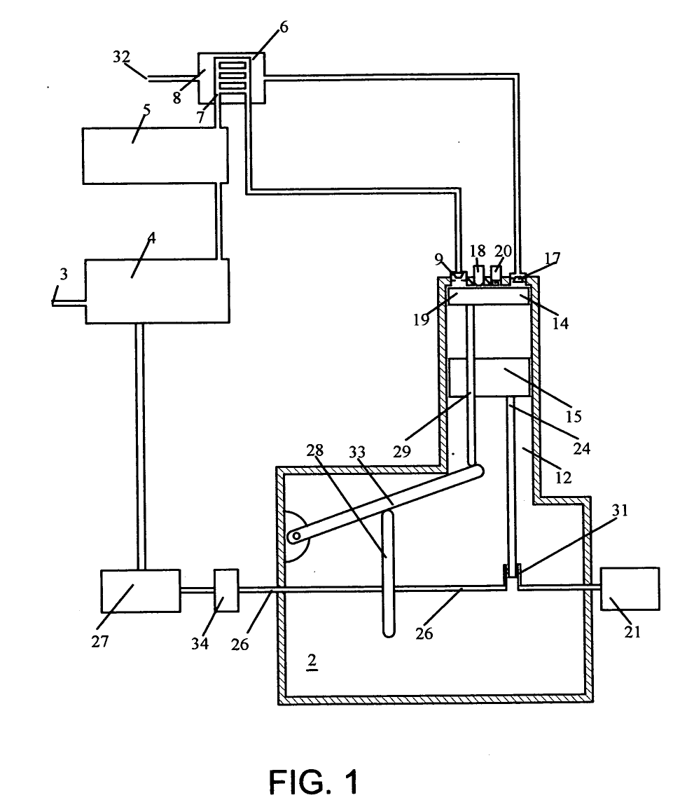

### Description—FIGS. 1 to 3—Preferred Embodiment

The preferred embodiment of this invention is the mechanization of a hot air engine cycle comprising nearly constant temperature compression, heat added from regeneration at near constant pressure, combustion heat added at nearly constant volume, close to adiabatic expansion, heat transferred to regeneration, and heat rejected from compressed air cooling.

Air is taken in through air inlet 3, and compressed by compressor 4. The compressed air is stored in compressed air storage tank 5. Heat is added at constant pressure by heat exchanger 6 with heat exchanger high-pressure side 7 and heat exchanger low-pressure side 8.

The hot compressed air is then used to drive expander 2. Expander 2 is made up of inlet valve 9, expansion cylinder 12, power piston 14, pusher piston 15, exit valve 17, fuel injector 18, clearance volume 19, igniter 20, pusher piston connecting rod 24, power output shaft 26, cam 28, push rod 29, pusher piston connecting rod crank 31, and arm 33. The volume between the top of expansion cylinder 12 and top of power piston 14 at the start of combustion is clearance volume 19. Pusher piston connecting rod 24 is connected to pusher piston connecting rod crank 31 on power output shaft 26 that is connected to load 21, clutch 34, and transmission 27. Transmission 27 drives compressor 4. Exit valve 17 allows the exhaust to flow through heat exchanger low-pressure side 8.

The engine has only one each of air inlet 3, compressor 4, compressed air storage tank 5, heat exchanger 6, transmission 27, exhaust exit 32, and clutch 34, but it can have many expanders 2.

To obtain maximum efficiency a compressor should operate as close to constant temperature as possible. For example, this may be accomplished by using a multi-stage-intercooled compressor as compressor 4.

The airflow control is shown using poppet type valves. These could be replaced with other type flow control devices.

Compressed air storage tank 5 can be an accumulator.

Although the air coming out of the heat exchanger high-pressure side 7 may be hot enough to ignite the fuel, igniter 20 is shown in all figures because it is needed to start the engine.

### Operation—FIGS. 1 to 3—Preferred Embodiment

Air enters the engine through air inlet 3, is compressed in multi-stage-intercooled compressor 4, is stored in compressed air storage tank 5, and is heated with heat from the exhaust by heat exchanger 6 as it passes through heat exchanger high-pressure side 7. The resulting hot compressed air drives expander 2.

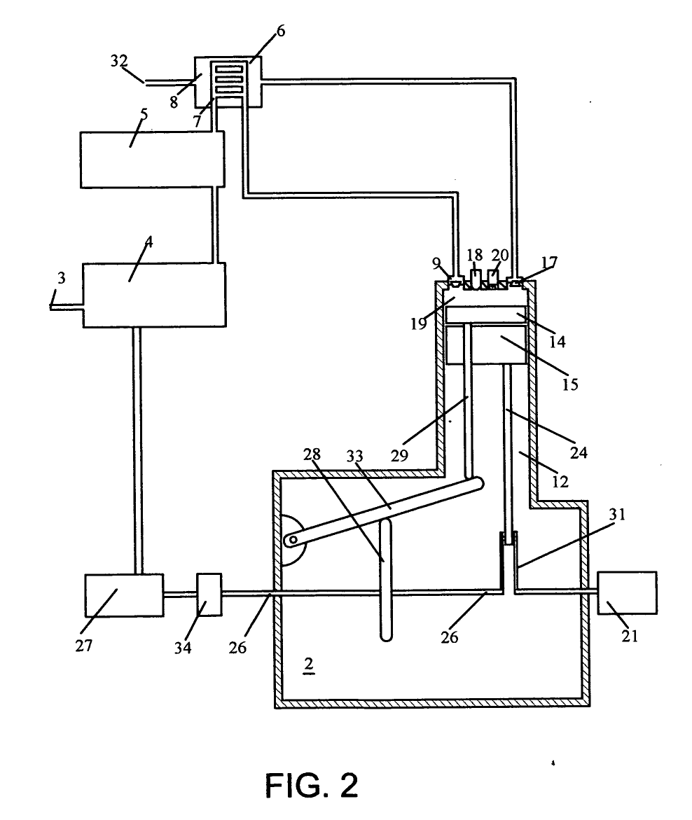

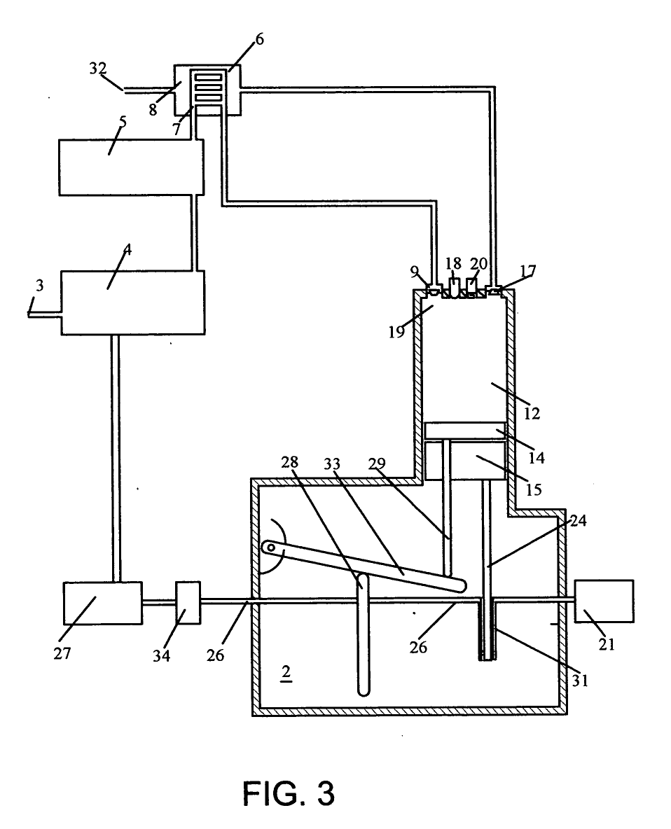

The cycle of expander 2 starts with exit valve 17 opening. Cam 28 along with arm 33 and push rod 29 pushes power piston 14 to the top of expansion cylinder 12, and keeps it there until the exhaust air is out of expansion cylinder 12, exit valve 17 closes and inlet valve 9 opens (as shown in FIG. 1). The incoming hot compressed air pushes power piston 14 down as much as cam 28 will allow, forming clearance volume 19. Cam 28 keeps power piston 14 in this position until fuel injector 18 injects fuel and igniter 20 ignites the fuel. At this time pusher piston 15 reaches the top of its travel and is up against power piston 14 (as shown in FIG. 2). Cam 28 falls away. The fuel continues to burn and increases the temperature and the resulting pressure pushes power piston 14 along with pusher piston 15, pusher piston connecting rod 24, pusher piston connecting rod crank 31, and power output shaft 26 producing output power. When power piston 14 nears the bottom of its travel (as shown in FIG. 3) exit valve 17 opens and the cycle of expander 2 repeats.

The inertia from the load slowing down can be used to continue to compress air. As the engine uses less than is compressed, the extra air is stored in compressed air storage tank 5. The extra air that is stored in compressed air storage tank 5 can be used to make the engine operate at higher work output. This is done by using clutch 34 to disconnect the compressor. The compressed air in storage is then used to operate the engine. This results in an increase in maximum work output equal to the work of compression.

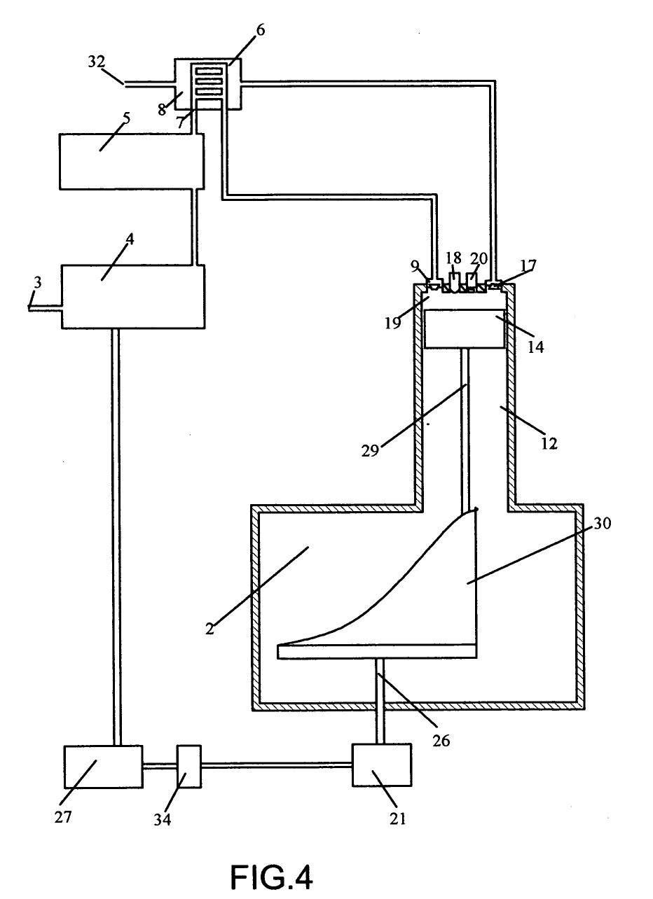

### Description—FIG. 4—First Alternate Embodiment

The first alternate embodiment of this invention is the preferred embodiment of this invention with approximate constant volume expansion achieved by keeping the power piston 14 close to the top of the expansion cylinder 12 and forming clearance volume 19 using wobble plate 30.

Air is taken in through air inlet 3, and approximate constant temperature compression is achieved by using a multi-stage-intercooled compressor as compressor 4. The compressed air is stored in compressed air storage tank 5. Heat is added to the compressed air at constant pressure by means of heat exchanger 6. Heat exchanger 6 is comprised of heat exchanger high-pressure side 7 and heat exchanger low-pressure side 8.

The hot compressed air is then used to drive expander 2. Expander 2 is made up of inlet valve 9, expansion cylinder 12, power piston 14, exit valve 17, fuel injector 18, clearance volume 19, igniter 20, power output shaft 26, push rod 29, and wobble plate 30. The volume between the top of expansion cylinder 12 and top of power piston 14 at the start of combustion is clearance volume 19. Wobble plate 30 is connected to power output shaft 26 that is connected to load 21, clutch 34, and transmission 27. Transmission 27 drives compressor 4. Exit valve 17 allows the exhaust to flow through heat exchanger low-pressure side 8.

The engine has only one each of air inlet 3, compressor 4, compressed air storage tank 5, heat exchanger 6, transmission 27, exhaust exit 32, and clutch 34, but it can have many expanders 2.

To obtain maximum efficiency a compressor should operate as close to constant temperature as possible. For example, this may be accomplished by using a multi-stage-intercooled compressor as compressor 4.

The airflow control is shown using poppet type valves. These could be replaced with other type flow control devices.

Compressed air storage tank 5 can be an accumulator.

### Operation—FIG. 4—First Alternate Embodiment

Air enters the engine through air inlet 3, is compressed in compressor 4, is stored in compressed air storage tank 5, and is heated with heat from the exhaust by heat exchanger 6 as it passes through heat exchanger high-pressure side 7. The resulting hot compressed air drives expander 2.

The cycle of expander 2 starts with exit valve 17 opening. Wobble plate 30 and push rod 29 push power piston 14 to the top of expansion cylinder 12, and keeps it there until the exhaust air is out of expansion cylinder 12, exit valve 17 closes and inlet valve 9 opens. The incoming hot compressed air pushes power piston 14 down as much as wobble plate 30 will allow forming clearance volume 19. Wobble plate 30 keeps power piston 14 in this position until fuel injector 18 injects fuel and igniter 20 ignites the fuel. The fuel continues to burn resulting in increased temperature and pressure. The increased pressure acts on power piston 14, push rod 29, wobble plate 30, and power output shaft 26 producing output power. When power piston 14 nears the bottom of its travel, exit valve 17 opens and the cycle of expander 2 repeats.

The inertia from the load slowing down can be used to continue to compress air. As the engine uses less than is compressed, the extra air is stored in compressed air storage tank 5. The extra air that is stored in compressed air storage tank 5 can be used to make the engine operate at higher power. This is done by using clutch 34 to disconnect the compressor. The compressed air in storage is then used to operate the engine. This results in an increase in maximum work output equal to the work of compression.

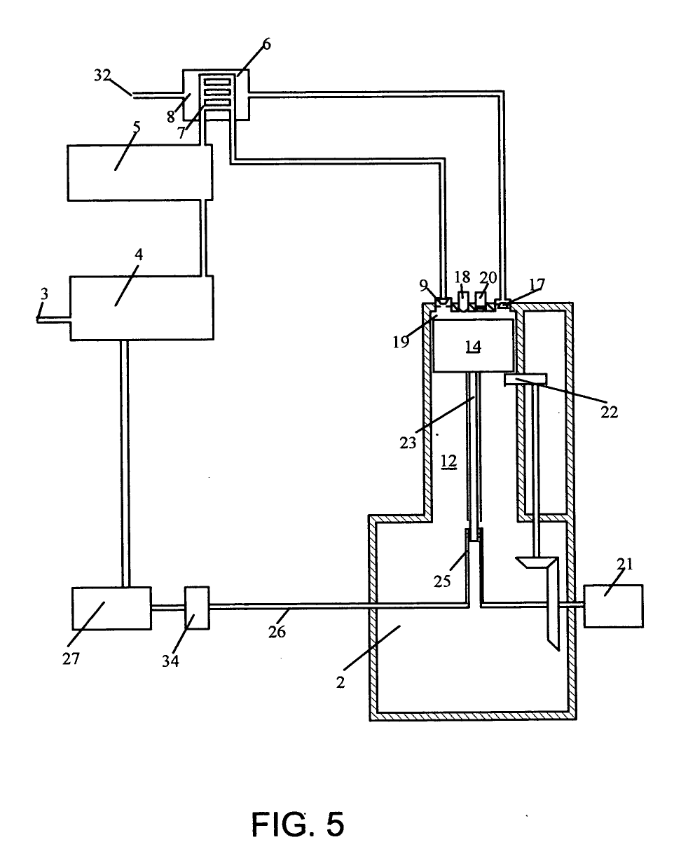

### Description—FIG. 5—Second Alternate Embodiment

The second alternate embodiment of this invention is the preferred embodiment of this invention with approximate constant volume expansion achieved by keeping the power piston 14 close to the top of the expansion cylinder 12 and forming clearance volume 19 using telescoping connecting rod 23, with internal pressurization, along with lock 22.

Air is taken in through air inlet 3, and approximate constant temperature compression is achieved by using a multi-stage-intercooled compressor as compressor 4. The compressed air is stored in compressed air storage tank 5. Heat is added to the compressed air at constant pressure by means of heat exchanger 6. Heat exchanger 6 is comprised of heat exchanger high-pressure side 7 and heat exchanger low-pressure side 8.

The hot compressed air is then used to drive expander 2. Expander 2 is made up of inlet valve 9, expansion cylinder 12, power piston 14, exit valve 17, fuel injector 18, clearance volume 19, igniter 20, lock 22, telescoping connecting rod 23, telescoping connecting rod crank 25, and power output shaft 26. The volume between the top of expansion cylinder 12 and top of power piston 14 at the start of combustion is clearance volume 19. Power piston 14, telescoping connecting rod 23, telescoping connecting rod crank 25, and power output shaft 26 are connected to load 21, clutch 34, and transmission 27. Transmission 27 drives compressor 4. Exit valve 17 allows the exhaust to flow through heat exchanger low-pressure side 8.

The engine has only one each of air inlet 3, compressor 4, compressed air storage tank 5, heat exchanger 6, transmission 27, exhaust exit 32, and clutch 34, but it can have many expanders 2.

To obtain maximum efficiency a compressor should operate as close to constant temperature as possible. For example, this may be accomplished by using a multi-stage-intercooled compressor as compressor 4.

The airflow control is shown using poppet type valves. These could be replaced with other type flow control devices.

Compressed air storage tank 5 can be an accumulator.

### Operation—FIG. 5—Second Alternate Embodiment

Air enters the engine through air inlet 3, is compressed in compressor 4, is stored in compressed air storage tank 5, and is heated with heat from the exhaust by heat exchanger 6 as it passes through heat exchanger high-pressure side 7. The resulting hot compressed air drives expander 2.

The cycle of expander 2 starts with exit valve 17 opening. Pressure, supplied by an outside source not shown, inside of telescoping connecting rod 23 pushes power piston 14 to the top of expansion cylinder 12, and keeps it there until the exhaust air is out of expansion cylinder 12, exit valve 17 closes, lock 22 swings into position below power piston 14, and inlet valve 9 opens. The incoming hot compressed air pushes power piston 14 down as much as lock 22 will allow forming clearance volume 19. Lock 22 keeps power piston 14 in this position until fuel injector 18 injects fuel and igniter 20 ignites the fuel. At this time telescoping connecting rod 23 becomes solid and reaches the top of its travel. Lock 22 swings out of position below power piston 14. The fuel continues to burn and increases the temperature and the resulting pressure pushes power piston 14 along with telescoping connecting rod 23, telescoping connecting rod crank 25, and power output shaft 26 producing output power. When power piston 14 nears the bottom of its travel (as shown in FIG. 3) exit valve 17 opens and the cycle of expander 2 repeats.

The inertia from the load slowing down can be used to continue to compress air. As the engine uses less than is compressed, the extra air is stored in compressed air storage tank 5. The extra air that is stored in compressed air storage tank 5 can be used to make the engine operate at higher power. This is done by using clutch 34 to disconnect the compressor. The compressed air in storage is then used to operate the engine. This results in an increase in maximum work output equal to the work of compression.

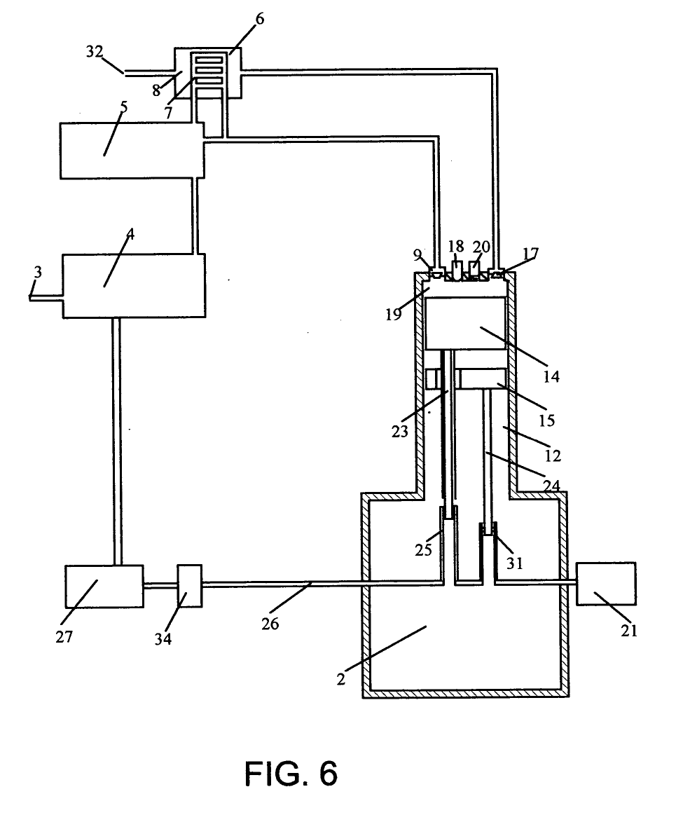

### Description—FIG. 6—Third Alternate Embodiment

The third alternate embodiment of this invention is the preferred embodiment of this invention with approximate constant volume expansion achieved by keeping the power piston 14 close to the top of the expansion cylinder 12 and forming clearance volume 19 using pusher piston 15, telescoping connecting rod 23, pusher piston connecting rod 24, along with telescoping connecting rod crank 25 and pusher piston connecting rod crank 31.

Air is taken in through air inlet 3, and approximate constant temperature compression is achieved by using a multi-stage-intercooled compressor as compressor 4. The compressed air is stored in compressed air storage tank 5. Heat is added to the compressed air at constant pressure by means of heat exchanger 6. Heat exchanger 6 is comprised of heat exchanger high-pressure side 7 and heat exchanger low-pressure side 8.

The hot compressed air is then used to drive expander 2. Expander 2 is made up of inlet valve 9, expansion cylinder 12, power piston 14, pusher piston 15, exit valve 17, fuel injector 18, clearance volume 19, igniter 20, telescoping connecting rod 23, pusher piston connecting rod 24, telescoping connecting rod crank 25, pusher piston connecting rod crank 31, and power output shaft 26. The volume between the top of expansion cylinder 12 and top of power piston 14 at the start of combustion is clearance volume 19. Power piston 14, pusher piston 15, telescoping connecting rod 23, pusher piston connecting rod 24, telescoping connecting rod crank 25, pusher piston connecting rod crank 31, and power output shaft 26 are connected to load 21, clutch 34, and transmission 27. Transmission 27 drives compressor 4. Exit valve 17 allows the exhaust to flow through heat exchanger low-pressure side 8.

The engine has only one each of air inlet 3, compressor 4, compressed air storage tank 5, heat exchanger 6, transmission 27, exhaust exit 32, and clutch 34, but it can have many expanders 2.

To obtain maximum efficiency a compressor should operate as close to constant temperature as possible. For example, this may be accomplished by using a multi-stage-intercooled compressor as compressor 4.

The airflow control is shown using poppet type valves. These could be replaced with other type flow control devices.

Compressed air storage tank 5 can be an accumulator.

### Operation—FIG. 6—Third Alternate Embodiment

Air enters the engine through air inlet 3, is compressed in compressor 4, is stored in compressed air storage tank 5, and is heated with heat from the exhaust by heat exchanger 6 as it passes through heat exchanger high-pressure side 7. The resulting hot compressed air drives expander 2.

The cycle of expander 2 starts with exit valve 17 opening. Telescoping connecting rod 23, pushes power piston 14 to the top of expansion cylinder 12, and keeps it there until the exhaust air is out of expansion cylinder 12, exit valve 17 closes, and inlet valve 9 opens. The incoming hot compressed air pushes power piston 14 down forming clearance volume 19. Pusher piston 15 coming up meets power piston 14 coming down and urges it back up. Fuel injector 18 injects fuel, igniter 20 ignites the fuel, and telescoping connecting rod 23 extends. The fuel continues to burn and increases the temperature and the resulting pressure pushes power piston 14 along with pusher piston 15, pusher piston connecting rod 24, pusher piston connecting rod crank 31, and power output shaft 26 producing output power. When power piston 14 nears the bottom of its travel exit valve 17 opens and the cycle of expander 2 repeats.

The inertia from the load slowing down can be used to continue to compress air. As the engine uses less than is compressed, the extra air is stored in compressed air storage tank 5. The extra air that is stored in compressed air storage tank 5 can be used to make the engine operate at higher power. This is done by using clutch 34 to disconnect the compressor. The compressed air in storage is then used to operate the engine. This results in an increase in maximum work output equal to the work of compression.

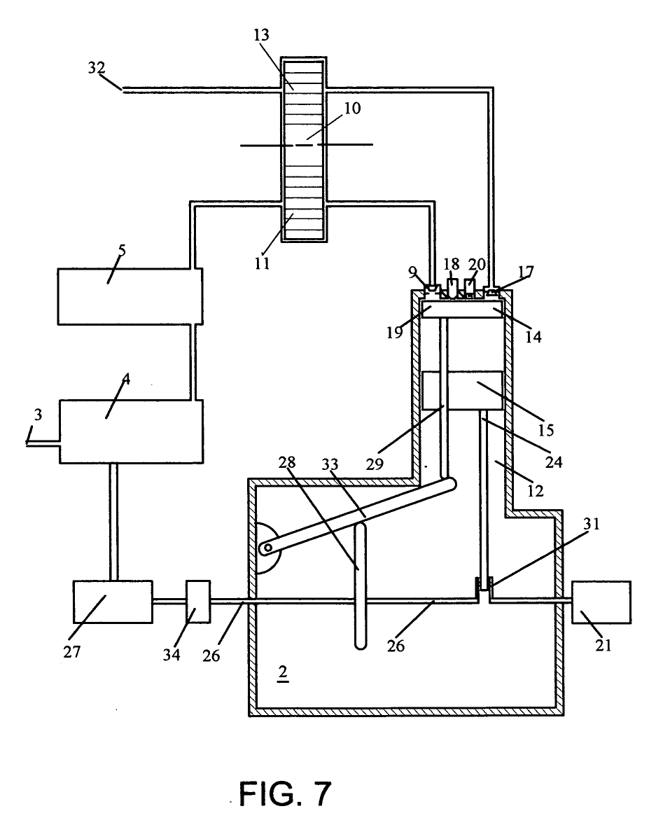

### Description—FIG. 7—Fourth Alternate Embodiment

The fourth alternate embodiment of this invention is the preferred embodiment of this invention with heat exchanger 6 replaced with a rotating heat exchanger 10 sometimes called a regenerator. Rotating heat exchanger 10 is shown in FIG. 7, and has rotating heat exchanger high-pressure side 11 and rotating heat exchanger low-pressure side 13.

### Operation—FIG. 7—Fourth Alternate Embodiment

The engine operates the same as the preferred embodiment of this invention. Air enters the engine through air inlet 3, is compressed in compressor 4, is stored in compressed air storage tank 5.

In rotating heat exchanger 10, as exhaust passes through rotating heat exchanger low-pressure side 13 it heats up from the exhaust heat. Rotating heat exchanger low-pressure side 13 then rotates and becomes rotating heat exchanger high-pressure side 11. As the compressed air from compressed air storage tank 5 passes through rotating heat exchanger high-pressure side 11 it heats the air up. The resulting hot compressed air drives expander 2.

### CONCLUSION

The “Improved Internal Combustion Engine” has the following advantages:

It operates on a very efficient thermodynamic cycle.

It operates with complete expansion.

Heat is added to the compressed air at constant volume so that more work can be done with the heat that is added.

When the load slows down it saves the inertia work and reuses it.

It is quiet.

The compression and the expansion volumes are separated. The heat from one does not affect the other.

I claim:

1. An internal combustion engine, comprising a compressor, a means to drive said compressor, a means to transfer heat from the exhaust gases to the compressed air, a power output shaft for attaching a load, and one or more similar expanders, each expander comprising;
a) a cylinder closed at one end;
b) an exit valve at the closed end of said cylinder;
c) a power piston in said cylinder;
d) a means to move said power piston to said exit valve end of said cylinder;
e) a means to move said power piston to form a clearance volume;
f) an inlet valve to allow compressed air to move into said clearance volume;
g) a means to increase the heat in said clearance volume;
h) a means to transfer increased pressure forces on said power piston to said power output shaft;

2. The engine of claim 1 wherein said compressor is a multi-stage-intercooled compressor.

3. The engine of claim 1 wherein said means to drive said compressor is a transmission connected to said output shaft.

4. The engine of claim 1 wherein said means to drive said compressor can be interrupted by a clutch.

5. The engine of claim 1 wherein said means to transfer heat from the exhaust gases to the compressed air is a heat exchanger.

6. The engine of claim 1 wherein said means to transfer heat from the exhaust gases to the compressed air is a rotating heat exchanger.

7. The engine of claim 1 wherein said means to increase the heat in said clearance volume is the burning of fuel.

8. The engine of claim 1 wherein said means to move said power piston to said exit valve end of said cylinder is a push rod moved by a cam on said power output shaft.

9. The engine of claim 1 wherein said means to move said power piston to form a clearance volume is a push rod moved by a cam on said power output shaft.

10. The engine of claim 1 wherein said means to transfer increased pressure forces on said power piston to said power output shaft is a pusher piston connected to a crank on said power output shaft.

11. The engine of claim 1 wherein said means to move said power piston to said exit valve end of said cylinder is a push rod moved by a wobble plate.

12. The engine of claim 1 wherein said means to move said power piston to form a clearance volume is a push rod moved by a wobble plate.

13. The engine of claim 1 wherein said means to transfer increased pressure forces on said power piston to said power output shaft is a push rod moved to move a wobble plate.

14. The engine of claim 1 wherein said means to move said power piston to said exit valve end of said cylinder is a telescoping connecting rod extended by the force of pressure inside it.

15. The engine of claim 1 wherein said means to move said power piston to form a clearance volume is a telescoping connecting rod extended by the force of pressure inside it and a lock.

16. The engine of claim 1 wherein said means to transfer increased pressure forces on said power piston to said power output shaft is a telescoping connecting rod connected to a crank on said power output shaft.

17. The engine of claim 1 wherein said means to move said power piston to said exit valve end of said cylinder is a telescoping connecting rod connected to a crank on said power output shaft.

18. The engine of claim 1 wherein said means to move said power piston to form a clearance volume is a telescoping connecting rod connected to a crank on said power output shaft.

19. The engine of claim 1 having a compressed air storage tank between said compressor and said heat exchanger.

20. An engine process operating on a cycle where air is compressed at near constant temperature, heat is added from regeneration at near constant pressure, heat is added at near constant volume, the air is expanded at near adiabatic conditions, heat is transferred to regeneration, and heat is rejected to ambient.
